(19) United States
(12) Patent Application Publication
(10) Pub. No.: US 2004/0197484 A1
(43) Pub. Date: Oct. 7, 2004

(54) Coating liquid for forming insulating film and method for producing insulating film

(75) Inventor: Yuji Yoshida, Edogawa-ku (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/806,279

(22) Filed: Mar. 23, 2004

(30) Foreign Application Priority Data
Mar. 27, 2003 (JP) 2003-088116

(51) Int. Cl. B05D 3/02

(52) U.S. Cl. 427/379; 427/372.2; 106/285; 106/287.11; 106/287.14; 106/287.16

(57) ABSTRACT

A coating liquid for forming insulating film which can form insulating film having high adhesion to semiconductor substrate is provided. The coating liquid for forming insulating film comprising following (A) and (B), wherein a water content in the coating liquid is not more than 1% by weight:

(A): a heat-reactive nonpolar compound or polymer thereof wherein the heat-reactive nonpolar compound is selected from the group consisting of a compound having not less than two C—C double bonds, a compound having not less than two C—C triple bonds and a compound having at least one C—C double bond and at least one C—C triple bond, (B): at least one compound selected from the group consisting of silane compounds represented by following formulae (1) to (3).

### FIELD OF THE INVENTION

The present invention relates to a coating liquid for insulating film.

### BACKGROUND OF THE INVENTION

Recently, with finer wiring required for a semiconductor device, a signal transfer speed is decreased, which is so-called RC delay. To improve RC delay, it is necessary to reduce interference between wiring by improving a performance of an insulating film, therefore a development of an insulating film having low dielectric constant is attempted.

Polyarylene attract attention as a material for insulating film having low dielectric constant. However, since it has no polar group, it adheres insufficiently to a semiconductor substrate such as silicon, silicon oxide, aluminum, copper, silicon nitride and the like, when making it insulating film.

As a method for improving the strength between insulating film of polyarylene and a semiconductor substrate, a coating liquid in which an additive that contains polysiloxane obtained by partially hydrolyzing a silane coupling agent having vinyl group is added to polyphenylene has been known (JP NO. 2002-523549 A). However, the insulating film obtained from said coating liquid is not adhering sufficiently to a substrate.

### SUMMARY OF THE INVENTION

The present invention is to provide a coating liquid for forming insulating film capable of forming an insulating film having high adhesion to a semiconductor substrate.

The present inventors have intensively studied to find a coating liquid for forming an above insulating film and resultantly found that a coating liquid containing a heat-reactive compound having not less than two unsaturated bonds or a polymer thereof and a certain kind of silane compound forms an insulating film having high adhesion to a semiconductor substrate, leading to completion of the present invention.

Namely, the present invention provides a coating liquid for forming insulating film comprising following (A) and (B), wherein a water content in the coating liquid is not more than 1% by weight:

(A): a heat-reactive nonpolar compound or a polymer thereof; wherein the heat-reactive nonpolar compound is selected from the group consisting of a compound having less than two carbon-carbon double bond, a compound having not less than two carbon-carbon triple bond, and a compound having at least one carbon-carbon double bond and at least one carbon-carbon triple bond,

(B): at least one compound selected from the group consisting of silane compounds represented by following formulae (1) to (3).

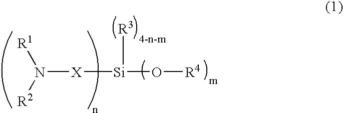

(wherein, R¹ and R² independently represent hydrogen atom, alkyl group having 1 to 4 carbon atoms, or aryl group having 6 to 20 carbon atoms, R³ represents alkyl group having 1 to 4 carbon atoms or aryl group having 6 to 20 carbon atoms, R⁴ represents alkyl group having 1 to 4 carbon atoms, acyl group having 1 to. 4 carbon atoms or aryl group having 6 to 20 carbon atoms , X represents bivalent group, n and m represent integers of from 1 to 3, and n+m is not more than 4.)

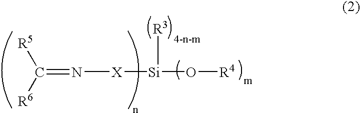

(wherein, R³, R⁴, n and m are as defined above, R⁵ and R⁶ independently represent hydrogen atom or monovalent organic group, providing that both R⁵ and R⁶ are not hydrogen atoms.)

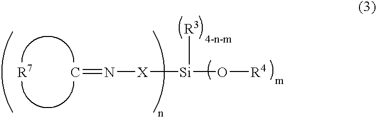

(wherein, R³, R⁴, n and m represent are as defined above, R⁷ represents alkylene group having 3 to 8 carbon atoms.)

### DESCRIPTION OF THE PREFERRED ENBODIMENTS

Water content in the coating liquid of the present invention is not more than 1% by weight, and is preferably not more than 0.5% by weight and more preferably not more than 0.2% by weight.

(A) is a heat-reactive nonpolar compound, which is selected from the group consisting of a compound having not less than two carbon-carbon double bond, a compound having not less than two carbon-carbon triple bond, and a compound having at least one carbon-carbon double bond and at least one carbon-carbon triple bond, or a polymer obtained by polymerizing these heat-reactive nonpolar compound.

Nonpolar, herein, refers to a compound having no polar group which contains an atom other than carbon atom and hydrogen atom, such as ether group, carbonyl group, carboxyl group, amino group, nitro group, nitrile group, mercapto group, sulfone group, phosphone group, phosphine group and the like, in molecule.

Heat-reactive nonpolar compounds include a compound which is constructed with a skeleton of linear-chain hydrocarbon, blanched hydrocarbon, cyclic hydrocarbon such as cyclopentane, cyclohexane, cyclooctane, norbornane, cubane, adamantane, diadamantane and the like, aromatic ring such as benzene ring, naphthalene ring, anthracene ring, azulene ring, pentalene ring, annulene ring, fullerene ring and the like, and has not less than two carbon-carbon double bonds or not less than two carbon-carbon triple bonds or at least one carbon-carbon double bond and at least one carbon-carbon triple bond that are reactive on heating, in the skeleton or a side chain.

A heat-reactive nonpolar compound is preferably a compound having an adamantane ring. Since a compound having an adamantane ring is a thermodynamically stable molecule, it has good heat resistance and high stability against agents used in the process for manufacturing semiconductor such as washing agent and resist removing agent. In addition, since it is commercially available, therefore it is preferably used.

(A) is more preferably a compound of formula (7) or a polymer obtained by polymerization of said compounds.

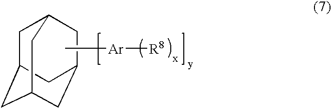

Wherein, Ar represents a group having an aromatic ring, and R⁸ represents a group represented by formula (8) or formula (9).

x represents an integer of from 1 to 3, wherein, when x is not less than 2, R⁸ may be same or different.

y represents an integer of from 1 to 3, wherein, when y is not less than 2, Ar and Re may be same or different, x×y (x times y) is an integer of from 2 to 9.

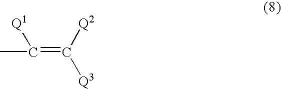

Wherein, each of Q¹ to Q³ independently represents hydrogen atom or hydrocarbon group.

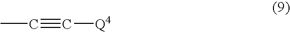

Wherein, Q⁴ represents hydrogen atom or hydrocarbon group. Examples of the hydrocarbon group include alkyl group having 1 to 4 carbon atoms, the alkylene group having 2 to 4 carbon atoms or the alkynylene group having 2 to 4 carbon atoms

Examples of the alkyl group having 1 to 4 carbon atoms include methyl group, ethyl group, propyl group, isopropyl group, butyl group, t-butyl group and the like.

Examples of the alkylene group having 2 to 4 carbon atoms include vinyl group, propenyl group, butenyl group and butadienyl group.

Examples of the alkynylene group having 2 to 4 carbon atoms include ethynyl group, propynyl group and butynyl group.

Ar in formula (7) includes a group composed of 1 to 3 aromatic rings that has no polar group, such as phenylene group, naphthalene group, biphenyl group, terphenylen group, methylphenylene group, methylnaphthalene group, methylanthracene group, ethylphenylene group, ethylnaphthalene group, ethylanthracene group, dimethylphenyl group, dimethylnaphthalene group, and trimethylnaphthalene group.

Examples of the group represented by formula (8) include vinyl group, propenyl group, butenyl group, butadienyl group, styrenyl group and the like.

Examples of the group represented by formula (9) include ethynyl group, propynyl group, butynyl group, phenylethynyl group and the like.

A method for preparing a compound represented by formula (7) includes, but not limited to, a method of connecting a bridging methine group of adamantane and a group represented by formula (8) or formula (9) and the like.

Said method comprises the steps of halogenizing a bridging methine group of adamantane with chlorine, bromine, iodine and the like, coupling with an aryl halide such as bromobenzene, bromonaphthalene, bromoanthracene, bromobiphenyl, bromoterphenyl, dibromobenzene, dibromonaphthalene, dibromoanthracene, tribromobenzene, tribromonaphthalene, tribromoanthracene, iodobenzene, iodonaphthalene, iodoanthracene, iodobiphenyl, iodoterphenyl, diiodobenzene, diiodonaphthalene, diiodoanthracene, triiodobenzene, triiodonaphthalene and triiodoanthracene in the presence of Lewis acid catalyst such as aluminium chloride, tin chloride, antimony chloride, titanium chloride, aluminium bromide, tin bromide, antimony bromide and titanium bromide, to connect an aryl halide and the methine group of adamantane, and further coupling a halogen group bonding to the aryl group with a hydrogen atom of a compound represented by formula (10) or formula (11) by using Sonogashira coupling reaction, thereby, obtaining a compound of formula (7).

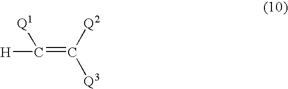

Wherein, Each of Q¹ to Q³ independently is as defined above.

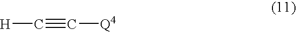

Wherein, Q⁴ is as defined above.

When one of Q¹ to Q³ of formula (8) or Q⁴ of formula (9) is a hydrogen atom, a method of using a protect group such as trimethylsilyl group, triethylsilyl group, tributylsilyl group, trimethyltin group, triethyltin group, tributyltin group and the like, and substituting these protect group to hydrogen atom after above coupling reaction may be used.

A group of formula (9) is preferred, because it can be imparted high heat-resistance by converting with heat reaction to phenyl group, polyvinylene group, diacetylene group substituted with phenyl group, alkyl group or phenyl group, and more preferably a group of formula (9) is ethynyl group or phenylethynyl group.

Specific examples of compound of formula (7) include

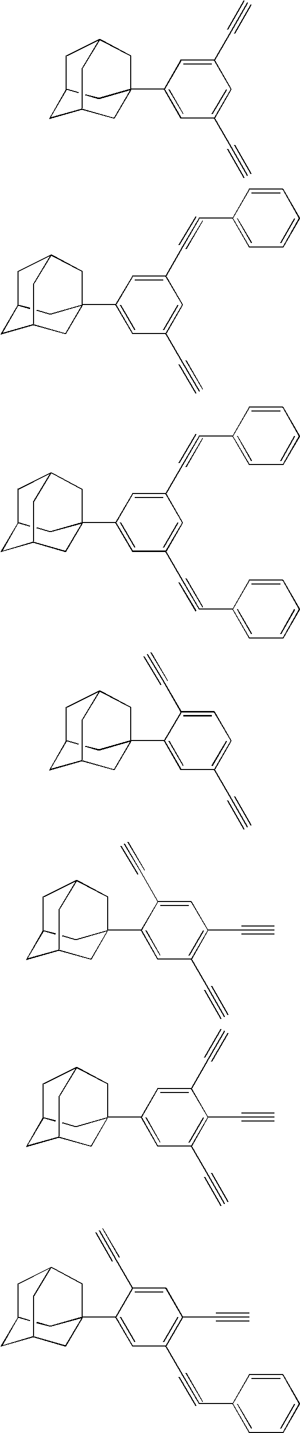

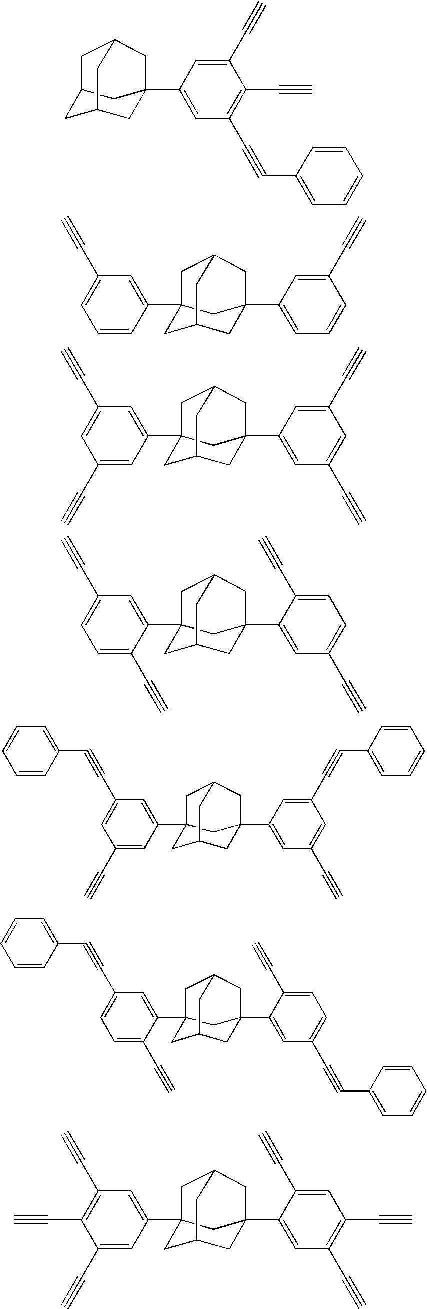

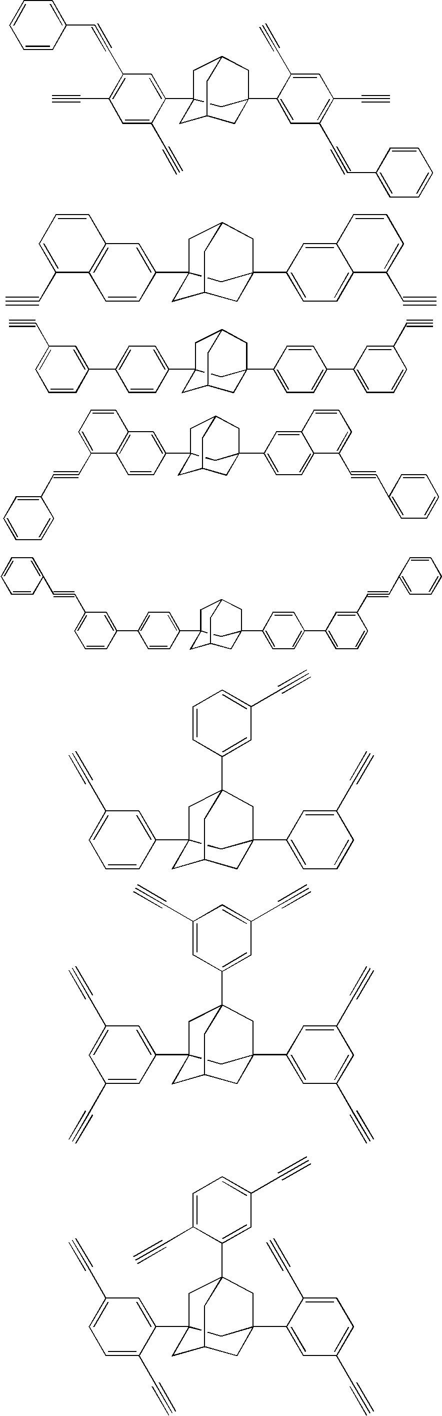

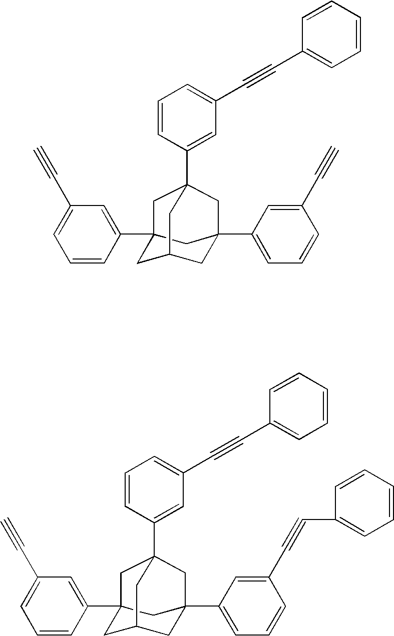

and the like.

For a method for polymerizing compound of formula (7), known methods of polymerizing may be employed, and include, for example, radical polymerization with radical initiator such as benzoyl peroxide, t-butyl peroxide, azobisisobutyronitrile and the like, cation polymerization with catalyst such as sulfuric acid, phosphoric acid, triethylaluminium, tungsten chloride and the like, anion polymerization with catalyst such as lithium naphthalene, photo-induced radical polymerization with light irradiation thermal polymerization in organic solvent and the like. In these methods, thermal polymerization is Preferable.

Polymerization, usually, progresses by reacting among carbon-carbon double bonds or among carbon-carbon triple bonds. Specific examples of polymer obtained include poly(diethynyladamantane), poly(triethynyladamantane), poly(tetraethynyladamantane)poly(bis(ethynylphenyl)adamanta ne), poly(tris(ethynylphenyl)adamantane), poly(bis(diethynylphenyl)adamantane), poly(tris(diethynylphenyl)adamantane), poly(bis(ethynylphenylethynyl)adamantane), poly(tris(ethynylphenylethynyl)adamantane) and the like.

(B) is at least one compound selected from the group consisting of silane compounds represented by following formulae (1) to (3).

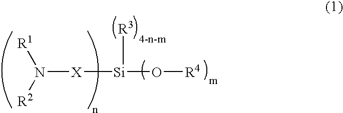

Wherein, R¹ and R² independently represent hydrogen atoms, alkyl group having 1 to 4 carbon atoms or aryl group having 6 to 20 carbon atoms. R³ represents alkyl group having 1 to 4 carbon atoms or aryl group having 6 to 20 carbon atoms. R⁴ represents alkyl group having 1 to 4 carbon atoms, acyl group having 1 to 4 carbon atoms or aryl group having 6 to 20 carbon atoms. X represents bivalent group. n and m represent integers of from 1 to 3, and n+m is not more than 4.

Examples of the alkyl group having 1 to 4 carbon atoms include methyl group, ethyl group, propyl group, isopropyl group, butyl group and the like.

Examples of the aryl group that may be substituted with alkyl group having 1 to 3 carbon atoms include phenyl group, naphthyl group, toluyl group, dimethylphenyl group, trimethylphenyl group, ethylphenyl group, diethylphenyl group, triethylphenyl group, propylphenyl group and the like.

Examples of the acyl group having 1 to 4 carbon atoms include formyl group, acetyl group, propylyl group, butylyl group and the like.

Examples of X group include methylene group, ethylene group, propylene group, butylene group, hexylen group phenylene group and naphtylene group and the like.

A compound represented by formula (1) includes are aminomethyltrimethoxysilane, aminomethyltriethoxysilane, aminomethyltripropoxysilane, aminomethyltributoxysilane, aminomethyltriphenoxysilane, aminomethyltriacetoxysilane, aminomethyltripropionylsilane, aminoethyltrimethoxysilane, aminoethyltriethoxysilane, aminoethyltripropoxysilane, aminoethyltributoxysilane, aminoethyltributoxysilane, aminoethyltriphenoxysilane, aminoethyltriacetoxysilane, aminoethyltripropionylsilane, aminopropyltrimethoxysilane, aminopropyltriethoxysilane, aminopropyltripropoxysilane, aminopropyltributoxysilane, aminophenyltrimethoxysilane, aminophenyltriethoxysilane, aminophenyltripropoxysilane, aminophenyltributoxysilane, aminonaphthyltrimethoxysilane, aminonaphthyltriethoxysilane, N-(aminoethyl)aminoethyltrimethoxysilane, N-(aminoethyl)aminoethyltriethoxysilane, N-(aminoethyl)aminoethyltripropoxysilane, N-(aminoethyl)aminoethyltributoxysilane, N-(aminoethyl)aminoethyltriphenoxysilane, N-(aminoethyl)aminoethyltriacetoxysilane, N-(aminoethyl)aminoethyltripropionylsilane, aminoethylmethyldimethoxysilane, aminoethylmethyidiethoxysilane, aminoethylmethyldiacetoxysilane, aminoethylethyldimethoxysilane, aminoethylethyldiethoxysilane, aminoethylethyldiacetoxysilane, aminoethylphenyldimethoxysilane, aminoethylphenyldiethoxysilane, aminoethylphenyldiacetoxysilane, aminoethyldimethylethoxysilane, aminoethyldiethyldiethoxysilane, aminoethylmethylphenylethoxysilane, aminoethylethylmethylethoxysilane, aminoethylmethylphenylethoxysilane, aminoethylethylphenylethoxysilane and the like. N-methylaminoethyltrimethoxysilane, N,N-dimethylaminoethyltrimethoxysilane, N-ethylaminoethyltrimethoxysilane, N,N-diethylaminoethyltrimethoxysilane, N-phenylaminoethyltrimethoxysilane, N,N-diphenylaminoethyltrimethoxysilane, N-toluylaminoethyltrimethoxysilane, N-(dimethylphenyl)aminoethyltrimethoxysilane, N-methylaminoethyltriethoxysilane, N,N-dimethylaminoethyltriethoxysilane, N-ethylaminoethyltriethoxysilane, N,N-diethylaminoethyltriethoxysilane, N-phenylaminoethyltriethoxysilane, N,N-diphenylaminoethyltriethoxysilane, N-toluylaminoethyltriethoxysilane, N-(dimethylphenyl)aminoethyltriethoxysilane, N-methylaminopropyltrimethoxysilane, N,N-dimethylaminopropyltrimethoxysilane, N-methylaminoethylmethyldiethoxysilane, N,N-dimethylaminoethylmethyldiethoxysilane, N-methylaminoethyltripropoxysilane, N-methylaminoethyltributoxysilane, N-methylaminoethyltrihexoxysilane, N,N-dimethylaminoethyltripropoxysilane, N,N-dimethylaminoethyltributoxysilane, N,N-dimethylaminoethyltrihexoxysilane,and the like.

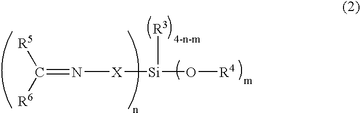

Wherein, R³, R⁴, n and m are as defined above. R⁵ and R⁶ independently represent hydrogen atom or monovalent organic group, providing that both R⁵ and R⁶ are not hydrogen atoms.

Examples of the monovalent organic group include alkyl group such as methyl group, ethyl group, propyl group, isopropyl group, butyl group, isobutyl group, t-butyl group, pentyl group, hexyl group, alkenyl group such as vinyl group, allyl-group, 1-propenyl group,1-butenyl group, 2-butenyl group, ethynyl group, 2-propynyl group, 2-butynyl group, hydroxyalkyl group such as hydroxymethyl group, hydroxyethyl group, hydroxypropyl group, hydroxybutyl group, alkoxyalkyl group such as methoxymethyl group, ethoxymethyl group, propoxymethyl group, butoxymethyl group, methoxyethyl group, ethoxyethyl group, propoxyethyl group, butoxyethyl group, methoxypropyl group, ethoxypropyl group, alkylcarbonylalkyl group such as acetylmethyl group, propionylmethyl group, butyrylmethyl group, acetylethyl group, propionylethyl group, butyrylethyl group, acetylpropyl group, propionylpropyl group, alkoxycarbonyl alkyl group such as methoxycarbonylmethyl group, ethoxycarbonylmethyl group, propoxycarbonylmethyl group, butoxycarbonylmethyl group, methoxycarbonylethyl group, ethoxycarbonylethyl group, propoxycarbonylethyl group, butoxycarbonylethyl group, methoxycarbonylpropyl group, ethoxycarbonylpropyl group, aminoalkyl group such as aminomethyl group, aminoethyl group, aminopropyl group, aminobuthyl group, aryl group such as phenyl group, tolyl group, dimethylphenyl group, trimethylphenyl group, ethylphenyl group, diethyphenyl group, propylphenyl group, dipropylphenyl group, butylphenyl group, dibutylphenyl group, pentylphenyl group, dipentylphenyl group, naphtyl group, methylnaphtyl group, dimethylnaphtyl group, trimethylnaphtyl group, ethylnaphtyl group, diethylnaphtyl group, propylnaphtyl group, dipropylnaphtyl group, butylnaphtyl group, dibutylnaphtyl group, pentylnaphtyl group, dipentylnaphtyl group, diphenyl group, methyldiphenyl group, trimethyldiphenyl group, ethyldiphenyl group, diethydiphenyl group, propyldiphenyl group, dipropyldiphenyl group, methylnaphtyl group, butyldiphenyl group, dibutyldiphenyl group, pentyldiphenyl group, terphenyl group, cyclic ether group such as 2-furyl group, furfuryl group, and the like.

A compound represented by formula (2) includes

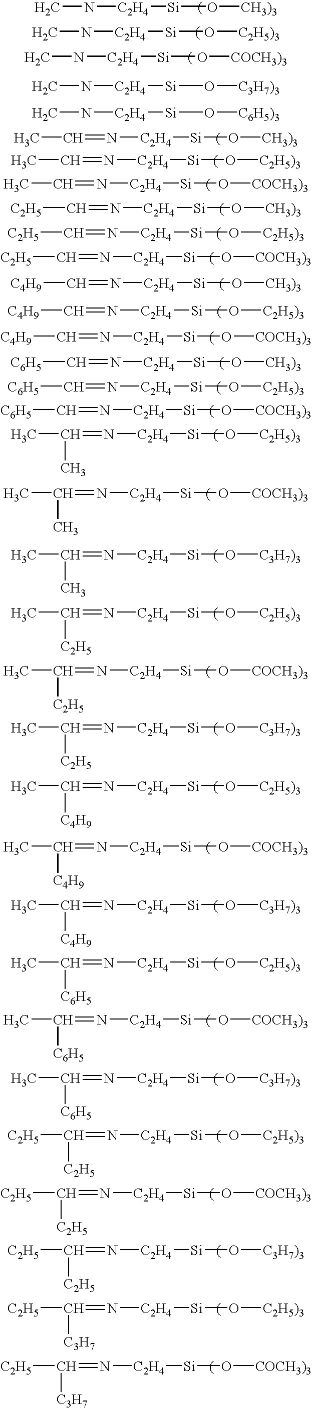

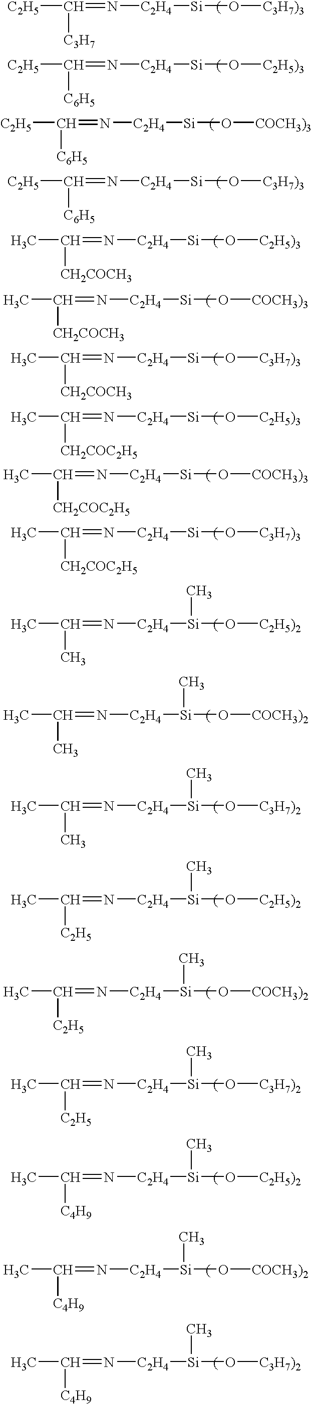

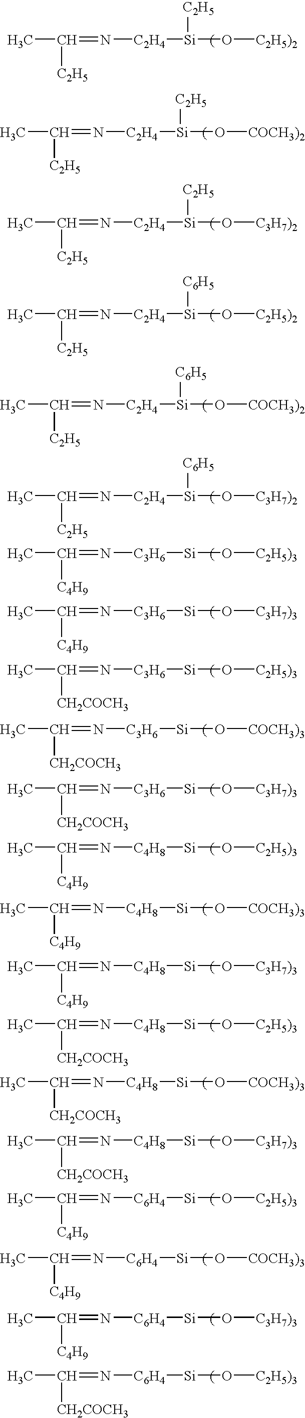

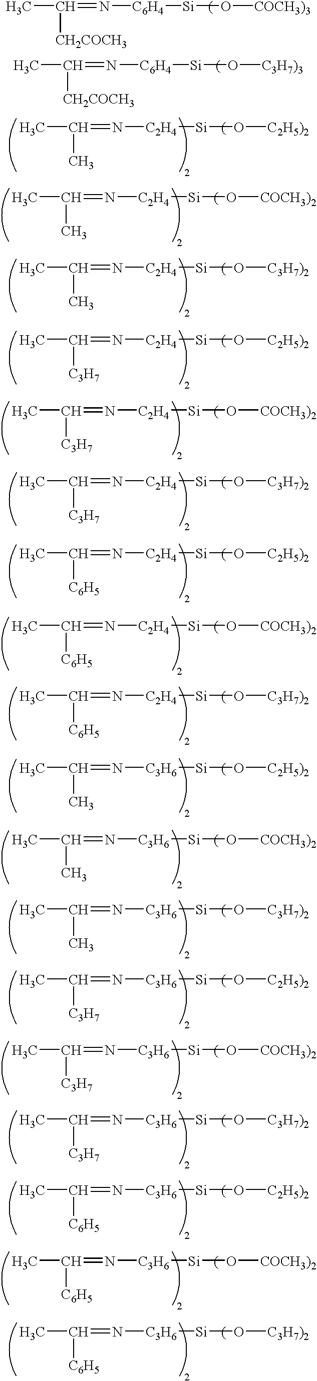

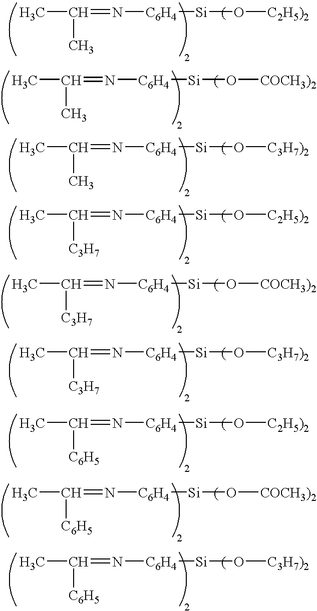

and the like.

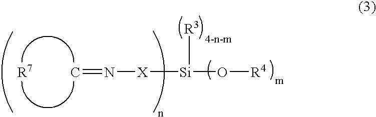

Wherein, R³, R⁴, n and m are as defined above, R⁷ represents alkylene group having 3 to 8 carbon atoms.

Examples of the alkylene group having 3 to 8 carbon atoms include trimethylene group, tetramethylene group, pentamethylene group, hexamethylene group, octamethylene group, methylpentamrthylene group, ethylpentamethylene group, dimethylpentamethylene group, methylhexamethylene group, ethylhexamethylene group and the like.

A compound represented by formula (3) includes

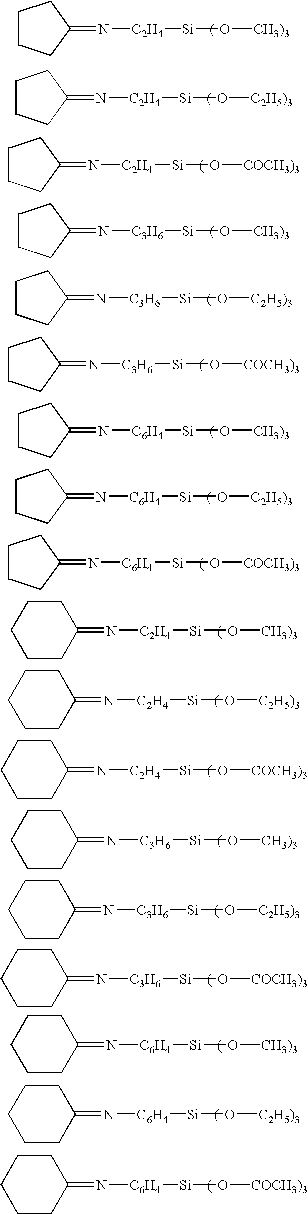

and the like.

A preferable compound of formula (1) is a compound of formula (4) which is equivalent to the compound of formula (1) when both R¹ and R² in formula (1) are hydrogen atoms in the view of adhesion to a substrate.

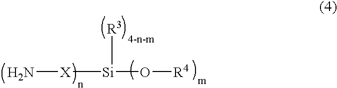

Wherein, R³, R⁴, n and m are as defined above.

A compound of formula (4), as it has amino group, usually shows adhesion by hydrogen bonding with polar group, and also can shows sufficient high adhesion in the insulating film obtained from the above-mentioned heat-reactive nonpolar compound on commercial manufacturing semiconductor device.

As a compound represented by formula (4), exemplified are aminomethyltrimethoxysilane, aminomethyltriethoxysilane, aminomethyltripropoxysilane, aminomethyltributoxysilane, aminomethyltriphenoxysilane, aminomethyltriacetoxysilane, aminomethyltripropionylsilane, aminoethyltrimethoxysilane, aminoethyltriethoxysilane, aminoethyltripropoxysilane, aminoethyltributoxysilane, aminoethyltributoxysilane, aminoethyltriphenoxysilane, aminoethyltriacetoxysilane, aminoethyltripropionylsilane, aminopropyltrimethoxysilane, aminopropyltriethoxysilane, aminopropyltripropoxysilane, aminopropyltributoxysilane, aminophenyltrimethoxysilane, aminophenyltriethoxysilane, aminophenyltripropoxysilane, aminophenyltributoxysilane, aminonaphthyltrimethoxysilane, aminonaphthyltriethoxysilane, aminoethylaminoethyltrimethoxysilane, aminoethylaminoethyltriethoxysilane, aminoethylaminoethyltripropoxysilane, aminoethylaminoethyltributoxysilane, aminoethylaminoethyltriphenoxysilane, aminoethylaminoethyltriacetoxysilane, aminoethylaminoethyltripropionylsilane, aminoethylmethyldimethoxysilane, aminoethylmethyldiethoxysilane, aminoethylmethyldiacetoxysilane, aminoethylethyldimethoxysilane, aminoethylethyldiethoxysilane, aminoethylethyldiacetoxysilane, aminoethylphenyldimethoxysilane, aminoethylphenyldiethoxysilane, aminoethylphenyldiacetoxysilane, aminoethylphenyldimethoxysilane, aminoethylphenyldiethoxysilane, aminoethylphenyldiacetoxysilane, aminoethyldimethylethoxysilane, aminoethyldiethyldiethoxysilane, aminoethylmethyldiphenylethoxysilane, aminoethylethylmethylethoxysilane, aminoethylmethylphenylethoxysilane, aminoethylethylphenylethoxysilane and the like.

Among these, 2-aminoethyltrimethoxysilane, 2-aminoethyltriethoxysilane, 3-aminopropyltrimethoxysilane, 3-aminopropyltriethoxysilane, 2-aminoethyltriacetoxysilane, 3-aminopropyltriacetoxysilane is preferably used as these are readily available.

A compound of formula (2) or formula (3) may be obtained by condensation of a compound of formula (4) with a compound of formula (5) or formula (6).

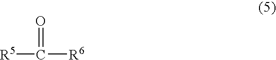

Wherein, R⁵ and R⁶ are as defined above.

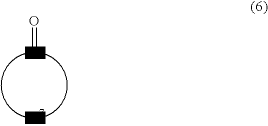

Wherein, R⁷ is as defined above.

A compound represented by formula (5) include acetone, methylethylketone, methylpropylketone, methylbutylketone, methylisobutylketone, 2-heptanone, acetophenone, methyltoluylketone, methylnaphthylketone, 3-hexanone, 3-heptanone, ethylhexylketone, ethylphenylketone, 4-octanone, butylphenylketone, hexylphenylketone, dibutylketone, dipentylketone, dihexylketone, benzophenone, acetaldehyde, propionylaldehyde, butylaldehyde, hexylaldehyde, benzaldehyde, methoxyacetone, 4-metoxybutan-2-one, 1-metoxubutan-2-on, acetylacetone, 2,4-hexandione, 3,5-hexandione, 2,4-heptandione, 3,5-heptandione, 1-phenyl-1,3-butandione and the like.

A compound represented by formula (6) includes a compound indicated below.

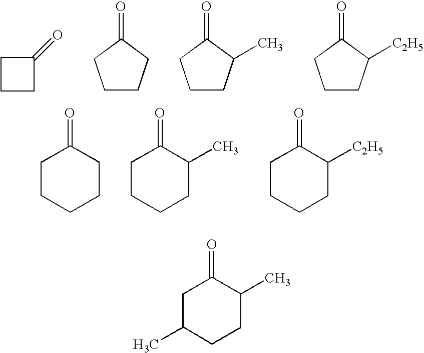

Reaction of a compound of formula (4) with a compound of formula (5) or formula (6) include forexample, a method ofusing azeotropic dehydration described in JP No. 07-247294 A (1995), a method of reacting in the presence of sulfate anhydrous described in JP No. 07-247295 A (1995).

In the reaction, oligomers as byproduct are generated by hydrolysis and condensation of OR⁴ groups of compounds of formula (2) and formula (3). These oligomers can be separated by distillation as described in the above-mentioned, or may be used directly in the present invention.

In contrast, when heated in the atmosphere, a compound of formula (2) or formula (3) decomposes with moisture in air to eliminate a compound of formula (5) or formula (6), resulting a compound of formula (4).

In a process of forming insulating film for semiconductor, the step of pre-baking under atmospheric pressure at 50 to 250° C. is generally used to remove coating solvent. In said step of pre-baking, a reaction described below is occurred and a compound of formula (4) is generated. From the view where a compound of formula (5) or formula (6) evaporates/volatiles at this time, a compound of boiling point not more than 250° C. is preferable.

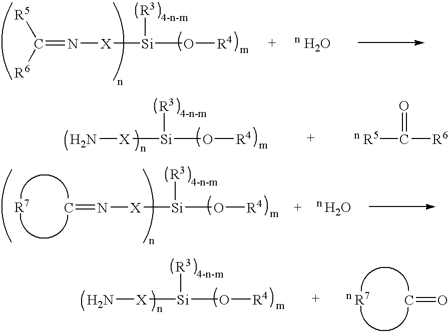

A compound of formula (5) or formula (6) is more preferably methylethylketone, 2-butanone, 2-pentanone, 3-pentanone, methylbutylketone, methylisobutylketone, 2-heptanone, 3-heptanone, acetylacetone because these are industrially readily available and have low toxicity and high volatility.

An amount added of (B) is preferably 0.01 to 10% by weight to (A), and more preferably 0.05 to 5% by weight. When lower than 0.01%, adhesion to semiconductor substrate may to be decreased. When higher than 10% by weight, relative dielectric constant may be deteriorated, and etching residue, which is so-called glass-formation, is generated in large quantity on processing insulating film by dry-etching and the like, resulting a burden on cleaning, therefore the operation on manufacturing semiconductor device may become complicated.

The coating liquid for forming insulating film of the present invention can be obtained by dissolving (A) and (B) in organic solvent.

An organic solvent used includes alcohols such as methanol, ethanol, isopropanol, 1-butanol, 2-butanol, 1-hexanol, 2-ethoxymethanol and 3-methoxypropanol; ketones such as acetylacetone, methylethylketone, methylisobutylketone, 2-pentanone, 3-pentanone, 2-heptanone and 3-heptanone; esters such as ethyl acetate, propyl acetate, butyl acetate, isobutyl acetate, pentyl acetate, ethyl propionate, propyl propionate, butyl propionate, isobutyl propionate, propylene glycol monomethyl ether acetate, methyl lactate, ethyl lactate and y-butyrolactone; ethers such as diisopropyl ether, dibutyl ether, ethylpropyl ether, anisole, phenetole and veratrole; aromatic hydrocarbons such as mesitylene, ethylbenzene, diethylbenzene and propylbenzene and the like, because these are industrially available and safety. These may be used alone or mixture of two or more.

Although an insulating film obtained from the above-mentioned coating liquid comprising (A) and (B) has sufficient adhesion to semiconductor substrate (C), which is a compound having a polar group and not less than two carbon-carbon double group or having not less than two carbon-carbon triple group, may be added.

(C) includes following compounds.

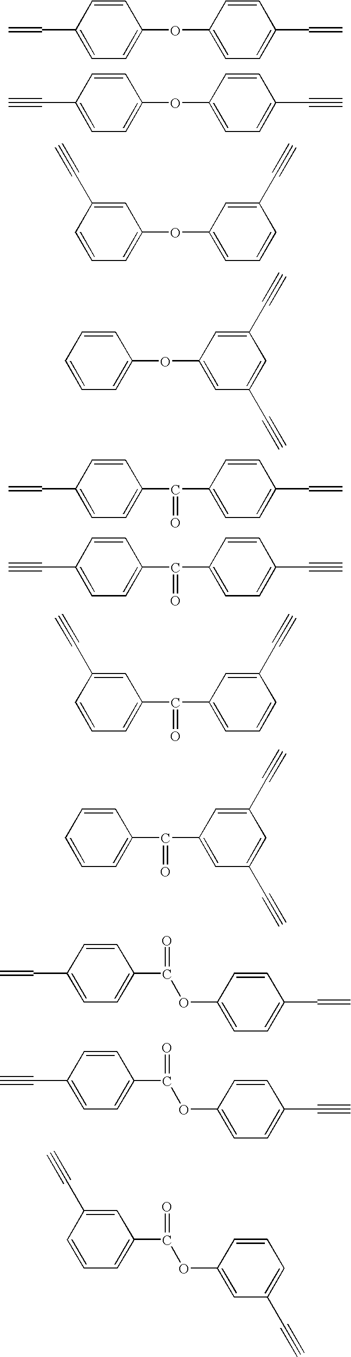

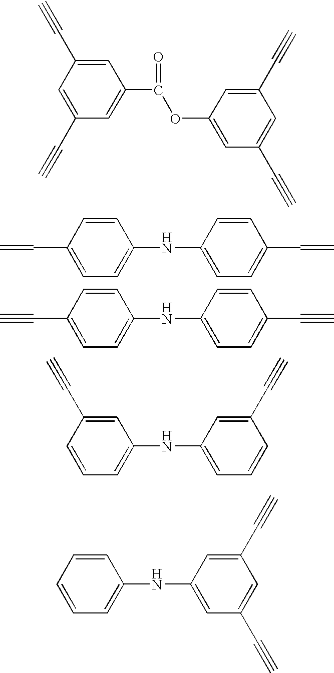

An amount added of (C) is preferably not more than 20% by weight to (A), more preferably not more than 10% by weight, and still more preferably not more than 5% by weight. When higher than 20% by weight, relative dielectric constant may be decreased.

In addition, to the coating liquid for forming insulating film of the present invention, within a scope. which does not affect performances of a compound of formula (1) such as reactivity and coating property, an additive such as radical generator, nonionic surfactant, fluorinated nonionic surfactant may be added.

Examples of the radical generator include t-butyl peroxide, pentyl peroxide, hexyl peroxide, lauroyl peroxide, benzoyl peroxide, azobisisobutyronitrile and the like.

Examples of the nonionic surfactant include octylpolyethylene oxide, decylpolyethylene oxide, dodecylpolyethylene oxide, octylpolypropylene oxide, decylpolypropylene oxide, dodecylpolypropylene oxide and the like.

Examples of the fluorinated nonionic surfactant include perfluorooctylpolyethylene oxide, perfluorodecylpolyethylene oxide, perfluorododecylpolyethylene oxide and the like.

An insulating film can be formed by coating a substrate with the coating liquid for forming insulating film of the present invention by any method such as spin-coating, roller-coating, dip-coating and scanning, baking under the atmosphere at 80 to 250° C. in the air, and further applying such methods as heating with hot-plate in inert gas (such as nitrogen, helium, argon, xenon) or under reduced pressure not more than 0.1 atmospheric pressure, using furnace oven, photo-irradiation-heating with xenon lamp by RTP (Rapid Thermal Processor) and the like.

As a result of coupling among carbon-carbon double bonds and carbon-carbon triple bonds by heating to form three dimensional structure, it is possible to form an insulating film having excellent mechanical strength and heat resistance. Final heating temperature is preferablyabout 200 toabout 450° C., and more preferably about 250 to about 400° C. Heating time is usually about one minute to about ten hours.

Resulting insulating film may be porous film by adding foaming agent in the coating liquid.

An insulating film obtained from the coating liquid for forming insulating film of the present invention has low relative dielectric constant, excellent heat resistance and excellent adhesion to semiconductor substrate, therefore it can be used preferably for interlayer insulating film in semiconduct or chip, passivation layer, protective film of semiconductor device.

### EXAMPLES

The following examples illustrate the present invention further in detail, but these donot limit the scope of the present invention.

### Example 1

1,3-bis (3,5-diethynylphenyl) adamantane was dissolved in anisole to give a solid content 15% by weight. Further 3-aminopropyltriethoxysilane was added to be 1% by weight to 1,3-bis (3,5-diethynylphenyl) adamantane, and then filtrating with 0.2 μm PTFE filter, a coating liquid was prepared.

The resulting coating liquid was spin-coated on a 4-inch silicon wafer at a revolution of 2000 rpm, and pre-baked for 1 minute at 150° C., then, heat-treated at 400° C. for 30 minutes under nitrogen atmosphere. The relative dielectric constant of the resulting insulating film was measured according to a mercury probe method (SSM495 type, manufactured by SSM Japan K.K.), and the adhesion was measured according to a Sebastian test (V type, manufactured by Quard Group). The results are listed in Table 1.

### Example 2

Same procedure as Example 1 was performed except that 3-aminopropyltriethoxysilane in Example 1 was changed to a compound of following formula. The results are listed in Table 1.

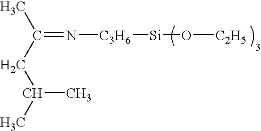

### Example 3

Same procedure as Example 1 was performed except that 3-aminopropyltriethoxysilane in Example 1 was changed to a compound of following formula. The results are listed in Table 1.

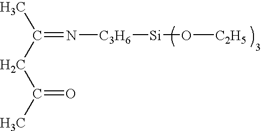

### Comparative Example 1

The same procedure as Example 1 was performed except that 3-aminopropyltriethoxysilane in Example 1 was changed to vinyltriethoxysilane. The results are listed in Table 1.

### Comparative Example 2

The same procedure as Example 1 was performed except that 3-aminopropyltriethoxysilane in Example 1 was not added. The results are listed in Table 1.

TABLE 1

| | relative dielectric | |
|---|---|---|
| | constant | adhesion |
| Example 1 | 2.69 | 62 MPa |
| Example 2 | 2.68 | 65 MPa |
| Example 3 | 2.70 | >70 MPa |
| Comparative Example 1 | 2.69 | 39 MPa |
| Comparative Example 2 | 2.71 | 10 MPa |

According to the present invention, it is possible to provide a coating liquid for forming insulating film which can form insulating film having high adhesion to semiconductor substrate.

1. A coating liquid for forming insulating film comprising (A) and (B), wherein a water content in the coating liquid is not more than 1% by weight:
(A): a heat-reactive nonpolar compound or polymer thereof, wherein the heat-reactive nonpolar compound is selected from the group consisting of a compound having not less than two carbon-carbon double bonds, a compound having not less than two carbon-carbon triple bonds, and a compound having at least one carbon-carbon double bond and at least one carbon-carbon triple bond,
(B): at least one compound selected from the group consisting of silane compounds represented by following formulae (1) to (3): 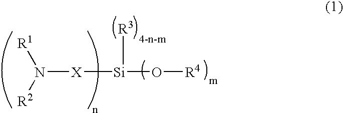
(wherein, R¹ and R² independently represent hydrogen atoms, alkyl group having 1 to 4 carbon atoms or aryl group having 6 to 20 carbon atoms, R³ represents alkyl group having 1 to 4 carbon atoms or aryl group that may be substituted with alkyl group having 1 to 3 carbon atoms, R⁴ represents alkyl group having 1 to 4 carbon atoms, acyl group having 1 to 4 carbon atoms or aryl group having 6 to 20 carbon atoms, X represents bivalent group, n and m is integers of from 1 to 3, providing that n+m is not more than 4), 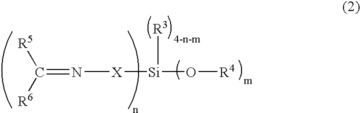
(wherein, R³, R⁴, n and m are as defined above, R⁵ and R⁶ independently represent hydrogen atom or monovalent organic group, providing that both R⁵ and R⁶ are not hydrogen atoms), and 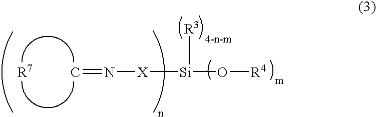
(wherein, R³, R⁴, n and m are as defined above, R⁷ represents alkylene group having 3 to 8 carbon atoms).

2. A coating liquid according to claim 1, wherein the compound of formula (1) is a compound of formula (4): 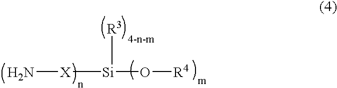
(R³, R⁴, n and m are as defined above).

3. A coating liquid according to claim 1 or 2, wherein the compound of formula (4) is at least one selected from the group consisting of 2-aminoethyltrimethoxysilane, 2-aminoethyltriethoxysilane, 3-aminopropyltrimethoxysilane, 3-aminopropyltriethoxysilane, 2-aminoethyltriacetoxysilane, 3-aminopropyltriacetoxysilane.

4. A coating liquid according to claim 1, wherein a compound of formula (2) or formula (3) is obtained by condensation of the compound of formula (4) with a compound of formula (5) or formula (6): 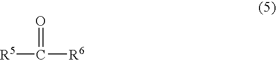
(wherein, R⁵ and R⁶ are as defined above), and 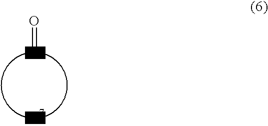
(wherein, R⁷ is as defined above).

5. A coating liquid according to claim 4, wherein the compound of formula (5) or formula (6) is a compound with boiling point not more than 250° C. under atmospheric pressure.

6. A coating liquid according to claim 4, wherein the compound of formula (5) is at least one selected from the group consisting of methylethylketone, 2-butanone, 2-pentanone, 3-pentanone, methylbutylketone, methylisobutylketone, 2-heptanone, 3-heptanone, acetylacetone.

7. The coating liquid according to claim 1, wherein the amount of (B) is from 0.01 to 10% by weight to (A).

8. A coating liquid according to claim 1, wherein (A) is a heat-reactive nonpolar compound having adamantane skeleton or a polymer of the heat-reactive nonpolar compound having adamantane skeleton.

9. A coating liquid according to claim 8, wherein (A) is a compound of formula (7) or a polymer of the compound of formula (7): 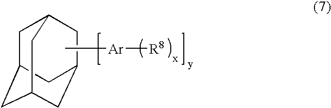
(wherein, Ar represents a group having an aromatic ring, R⁸ represents a group represented by formula (8) or formula (9), x represents an integer of from 1 to 3, wherein, when x is not less than 2, R⁸ may be same or different, y represents an integer of from 1 to 3, wherein, when y is not less than 2, Ar and R⁸ may be same or different, x x y is an integer of from 2 to 9), 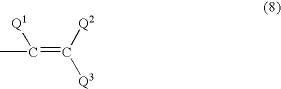
(wherein, each of Q¹ to Q³ independently represents hydrogen atom, alkyl group having 1 to 4 carbon atoms, alkenyl group having 2 to 4 carbon atoms, alkynyl group having 2 to 4 carbon atoms, or phenyl group), and 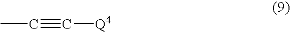
(wherein, Q⁴ represents hydrogen atom, alkyl group having 1 to 4 carbon atoms, alkenyl group having 2 to 4 carbon atoms, alkynyl group having 2 to 4 carbon atoms, or phenyl group).

10. A coating liquid according to claim 9, wherein the compound of formula (7) is a compound having Ar that bonds to methine group of adamantane skeleton.

11. A coating liquid according to claim 9 or 10, wherein R⁸ is a group of formula (9).

12. A coating liquid according to claim 9, wherein Rs is ethynyl group or phenylethynyl group.

13. A method for forming an insulating film comprising coating a substrate with the coating liquid according to claim 1, baking at 80 to 250° C. under atmospheric pressure in air, and heat-curing at 250 to 400° C.

14. An insulating film obtained by the method for forming according to claim 13.
